(19) United States
(12) Patent Application Publication
(10) Pub. No.: US 2015/0301432 A1
(43) Pub. Date: Oct. 22, 2015

(54) CAMERA DEVICE

(71) Applicant: GeoVision Inc., Taipei (TW)

(72) Inventors: Chih-Ming Wu, New Taipei City (TW); Min-Wei Chen, Taipei City (TW)

(73) Assignee: GeoVision Inc., Taipei (TW)

(21) Appl. No.: 14/254,903

(22) Filed: Apr. 17, 2014

(51) Int. Cl. G03B 17/08; H04N 5/225

(52) U.S. Cl. CPC G03B 17/08; H04N 5/2252; H04N 5/2254

(57) ABSTRACT

A camera device includes two independent housings and a connecting component. Each of the housing includes an encircled portion and an engaging portion. The encircled portion is disposed on an edge of the each housing, and an opening is formed on an encircled area of the encircled portion. The engaging portion is disposed on an outer surface of the encircled portion. The two encircled portions contact against each other to connect the two openings. The connecting component is movably disposed on the first encircled portion and the second encircled portion to assemble the first housing with the second housing. A second engaging portion of the connecting component is disposed on a side of the connecting component to engage with the first engaging portion. A second contacting portion of the connecting component is disposed on the other side of the connecting component to contact against the first contacting portion.

### BACKGROUND OF THE INVENTION

1. Field of the Invention

The present invention relates to a camera device, and more particularly, to a camera device with independent containers whereinside the lens module and the detachable component are respectively disposed to prevent moisture leakage of the lens module.

2. Description of the Prior Art

A conventional camera device includes a tube, a lens module and a plurality of electronic components. The electronic component is electrically connected to the lens module for controlling zoom in/out function of the lens module, and the lens module and the electronic components are both disposed inside the same tube. For repair/exchange of the electronic component, the tube is opened to expose the lens module and the electronic components, so as to detach the electronic component, such as the memory card and the I/O port, from the tube, or to actuate the electronic component, such as the reset button, for repairing a crash of the camera device. However, moisture easily leaks into the exposed lens module since the tube is opened to detach the electronic component, and design of a camera device with the specific sealed container for protection of the lens module is an important issue of the related camera industry.

### SUMMARY OF THE INVENTION

The present invention provides a camera device with independent containers whereinside the lens module and the detachable component are respectively disposed to prevent moisture leakage of the lens module for solving above drawbacks.

According to the claimed invention, a camera device includes a first housing, a second housing and a connecting component. The first housing includes a first encircled portion and a first engaging portion. The first encircled portion is disposed on an edge of the first housing, and a first opening is formed on an encircled area of the first encircled portion. The first engaging portion is disposed on an outer surface of the first encircled portion. The second housing includes a second encircled portion and a first contacting portion. The second encircled portion is disposed on an edge of the second housing, and a second opening is formed on an encircled area of the second encircled portion. The second encircled portion contacts against the first encircled portion to connect the first opening and the second opening. The first contacting portion is disposed on an outer surface of the second encircled portion. The connecting component is movably disposed on the first encircled portion and the second encircled portion to assemble the first housing with the second housing. The connecting component includes a second engaging portion and a second contacting portion. The second engaging portion is disposed on a side of the connecting component to engage with the first engaging portion. The second contacting portion is disposed on the other side of the connecting component to contact against the first contacting portion since the first engaging portion and the second engaging portion are engaged.

According to the claimed invention, the camera device further comprises a lens module and a detachable component respectively disposed inside the first housing and the second housing.

According to the claimed invention, the camera device further includes a waterproof component disposed between the first encircled portion and the second encircled portion. The waterproof component is adapted to simultaneously contact against the first encircled portion and the second encircled portion in a resiliently deformable manner.

According to the claimed invention, the first encircled portion, the second encircled portion and the connecting component are annular structures. The second engaging portion is rotatably engaged with the first engaging portion so as to press the second contacting portion on the first contacting portion.

According to the claimed invention, the first engaging portion and the second engaging portion are thread structures or protrusions.

According to the claimed invention, the outer surface of the second encircled portion includes a first area and a second area. The first contacting portion is disposed on the first area, and the second contacting portion slidably moves within the second area since the connecting component is assembled with the second housing.

According to the claimed invention, the first contacting portion and the second contacting portion are thread structures.

According to the claimed invention, the first engaging portion, the first contacting portion, the second engaging portion and the second contacting portion are inclined structures.

According to the claimed invention, the connecting component further includes two locking hole portions and a locking portion. The two locking hole portions are respectively disposed on ends of the connecting component. The locking portion passes through the two locking hole portions to press the second engaging portion on the first engaging portion, and to press the second contacting portion on the first contacting portion.

According to the claimed invention, first housing further includes a main body whereon the first encircled portion is disposed. A diameter of the first encircled portion is smaller than a diameter of the main body, and a thickness of the connecting component is substantially equal to diameter difference between the first encircled portion and the main body.

According to the claimed invention, the camera device further includes a transparent component disposed on the other edge of the first housing opposite to the first encircled portion in a hermetically sealed manner.

According to the claimed invention, a base of the lens module is fixed on the edge of the first housing to seal the first opening.

According to the claimed invention, the camera device further includes a moisture-proof component disposed between the base and the first housing.

According to the claimed invention, the camera device further includes a fixing component engaged with an inner surface of the first encircled portion to press the base on the first housing.

According to the claimed invention, the fixing component is an annular structure. The fixing component is rotatably engaged with the inner surface of the first encircled portion via thread structures.

According to the claimed invention, the camera device further includes a moisture-absorbing component disposed on the base of the lens module.

According to the claimed invention, a hole is formed on the base of the lens module. The lens module includes a connector and a watertight component. The connector passes through the hole to connect with a terminal of the detachable component, and the watertight component is disposed between the hole and the connector.

According to the claimed invention, the connector of the lens module is a board-to-board connector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an assembly diagram of a camera device according to a first embodiment of the present invention.

FIG. 2 is a disassembly diagram of the camera device according to the first embodiment of the present invention.

FIG. 3 and FIG. 4 respectively are sectional views of the camera device in different operational modes according to the first embodiment of the present invention.

FIG. 5 is an exploded diagram of a first housing and a lens module according to an embodiment of the present invention.

FIG. 6 is a sectional view of the first housing and the lens module according to the embodiment of the present invention.

FIG. 7 and FIG. 8 respectively are sectional views of the camera device in different operational modes according to a second embodiment of the present invention.

FIG. 9 is a sectional view of the camera device according to a third embodiment of the present invention.

FIG. 10 is a diagram of a connecting component according to the third embodiment of the present invention.

FIG. 11 and FIG. 12 respectively are diagrams of the camera device according to different embodiments of the present invention.

### DETAILED DESCRIPTION

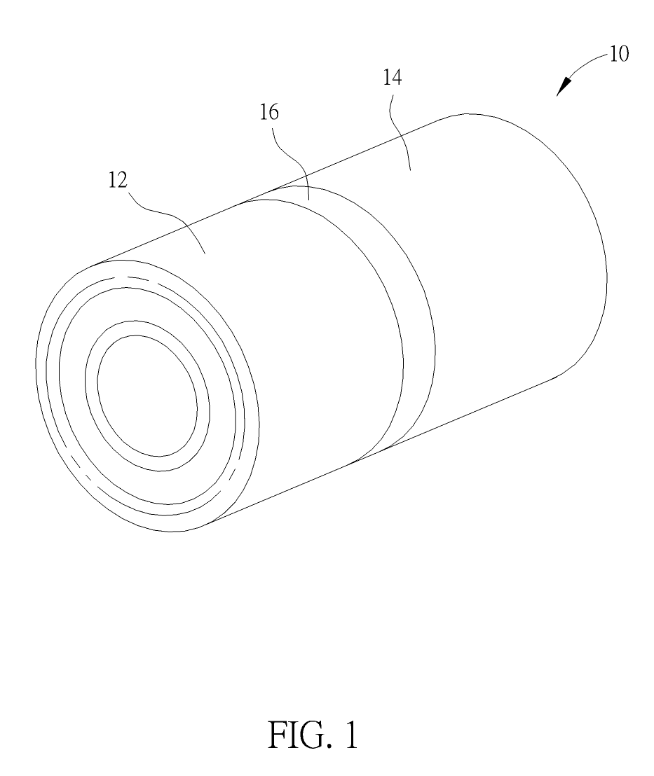

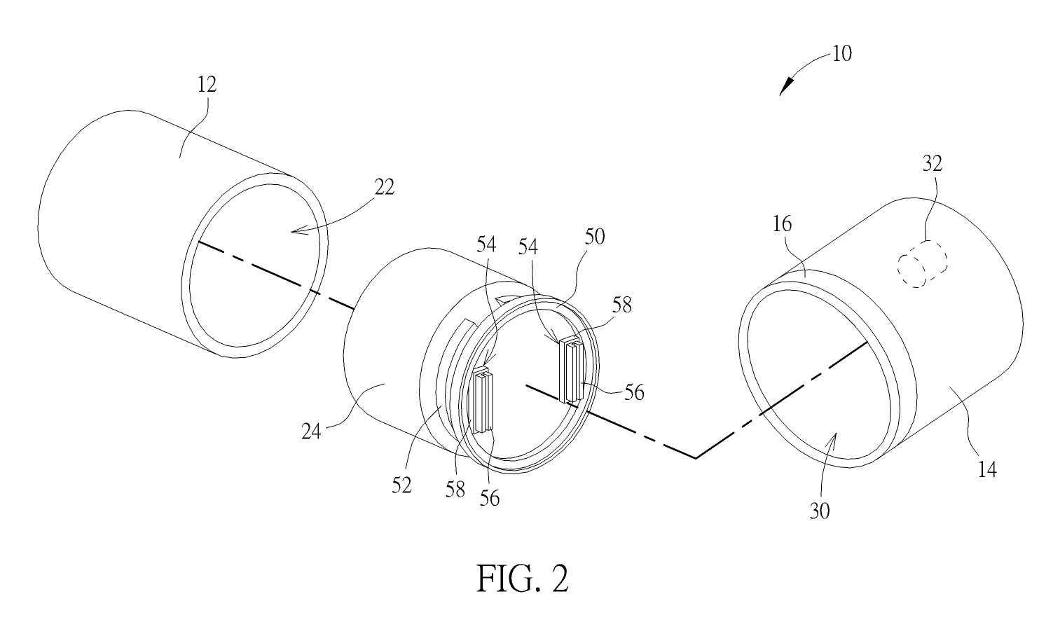

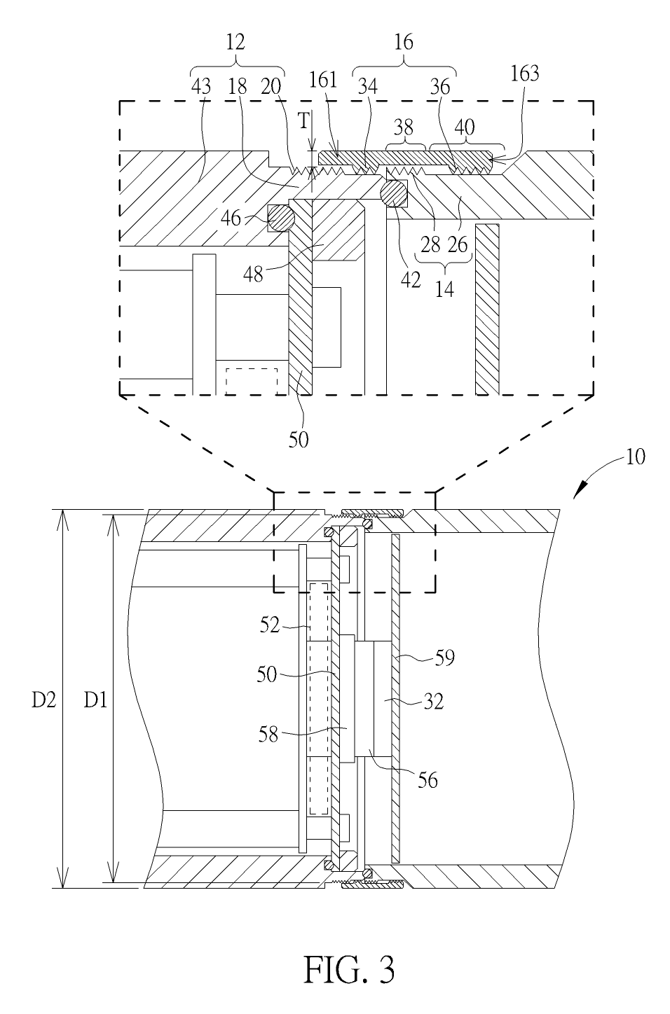

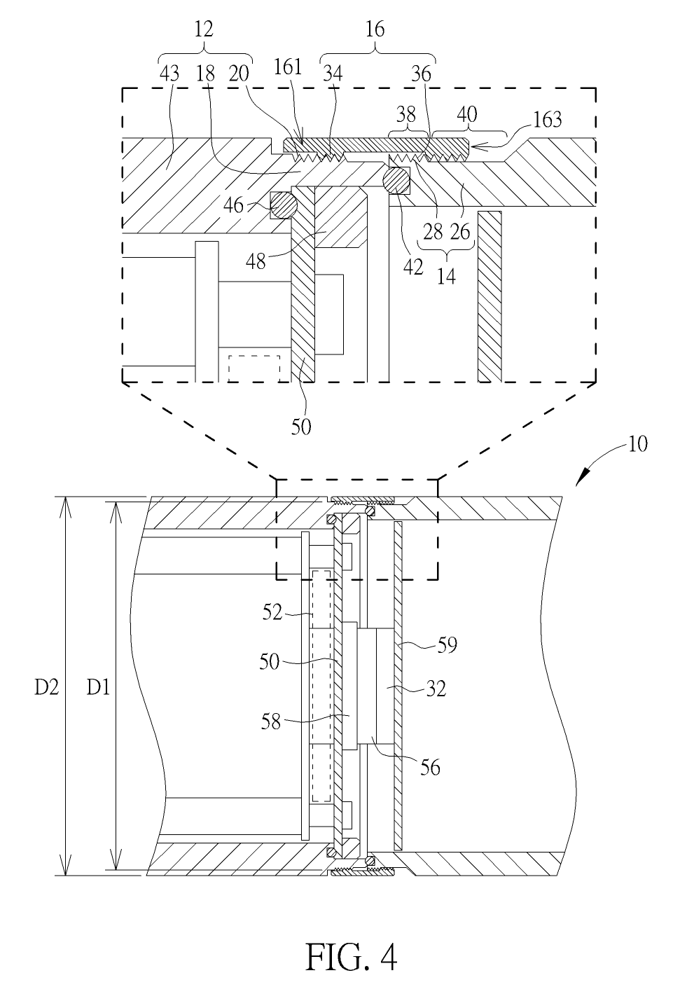

Please refer to FIG. 1 to FIG. 4. FIG. 1 is an assembly diagram of a camera device 10 according to a first embodiment of the present invention. FIG. 2 is a disassembly diagram of the camera device 10 according to the first embodiment of the present invention. FIG. 3 and FIG. 4 respectively are sectional views of the camera device 10 in different operational modes according to the first embodiment of the present invention. The camera device 10 includes a first housing 12, a second housing 14 and a connecting component 16. The connecting component 16 is utilized to assemble the first housing 12 with the second housing 14 to prevent a gap between the housings 12, 14 from moisture leakage. The first housing 12 includes a first encircled portion 18 and a first engaging portion 20. The first encircled portion 18 is disposed on an edge of the first housing 12, the first engaging portion 20 is disposed on an outer surface of the first encircled portion 18, and a first opening 22 is formed on an encircled area of the first encircled portion 18. A lens module 24 of the camera device 10 is disposed inside the first housing 12 via the first opening 22.

The second housing 14 includes a second encircled portion 26 and a first contacting portion 28. The second encircled portion 26 is disposed on an edge of the second housing 14, the first contacting portion 28 is disposed on an outer surface of the second encircled portion 26, and a second opening 30 is formed on an encircled area of the second encircled portion 26. A detachable component 32 of the camera device 10 is disposed inside the second housing 14 via the second opening 30. The detachable component 32 can be an I/O port or a memory card or a drive motor. The connecting component 16 is movably disposed on the first encircled portion 18 and the second encircled portion 26 to assemble the first housing 12 with the second housing 14. The connecting component 16 includes a second engaging portion 34 and a second contacting portion 36 respectively disposed on opposite sides 161,163 of the connecting component 16.

The outer surface of the second encircled portion 26 includes a first area 38 and a second area 40 adjacent to each other. The first contacting portion 28 is disposed on the first area 38. The first contacting portion 28 and the second contacting portion 36 may preferably be thread structures in the first embodiment. The connecting component 16 is assembled with the second housing 14 by rotary engagement between the first contacting portion 28 and the second contacting portion 36, and the second contacting portion 36 can slidably move within the second area 40 since the second contacting portion 36 passes through the first area 38 whereon the first contacting portion 28 is disposed, as shown in FIG. 3.

After assembly of the connecting component 16 and the second housing 14, the second encircled portion 26 contacts against the first encircled portion 18 to connect the first opening 22 and the second opening 30, the second engaging portion 34 is engaged with the first engaging portion 20 until the second contacting portion 36 tightly contacts against the first contacting portion 28. For example, the connecting component 16 moves from position shown in FIG. 3 to position shown in FIG. 4. The connecting component 16 drives the second housing 14 to move close to the first housing 12, so as to eliminate the gap between the first encircled portion 18 and the second encircled portion 26 and to prevent the housings 12, 14 from the moisture leakage. The first encircled portion 18, the second encircled portion 26 and the connecting component 16 can be annular structures, and the first engaging portion 20 and the second engaging portion 34 can be thread structures, so that the second engaging portion 34 is rotatably engaged with the first engaging portion 20 to tightly press the second contacting portion 36 on the first contacting portion 28.

The camera device 10 further includes a waterproof component 42 disposed between the first encircled portion 18 and the second encircled portion 26. One of the encircled portions 18, 26 may have a sunken portion whereinside the waterproof component 42 is partly accommodated. The waterproof component 42 is made of impermeable material, such as rubber. The waterproof component 42 is adapted to simultaneously contact against the first encircled portion 18 and the second encircled portion 26 in a resiliently deformable manner, and may be resiliently deformed when the first housing 12 is assembled with the second housing 14 by the connecting component 16, so as to fill the gap first encircled portion 18 and the second encircled portion 26 and to enhance moisture resistance of the camera device 10.

As shown in FIG. 3, the first housing 12 may include a main body 43 whereon the first encircled portion 18 is disposed. The main body 43 is an encircled portion larger than the first encircled portion 18, and the first encircled portion 18 stretches from an edge of the main body 43. A diameter D1 of the first encircled portion 18 is smaller than a diameter D2 of the first housing 12, a diameter of the second encircled portion 26 is also smaller than a diameter of the second housing 14, which means connection between the first housing 12 and the second housing 14 forms an indentation. A thickness T of the connecting component 16 is substantially equal to diameter difference between the first encircled portion 18 and the main body 43, and further equal to diameter difference between the second encircled portion 26 and main body of the second housing 14. Therefore, the camera device 10 can have a flat appearance for preferred aesthetic.

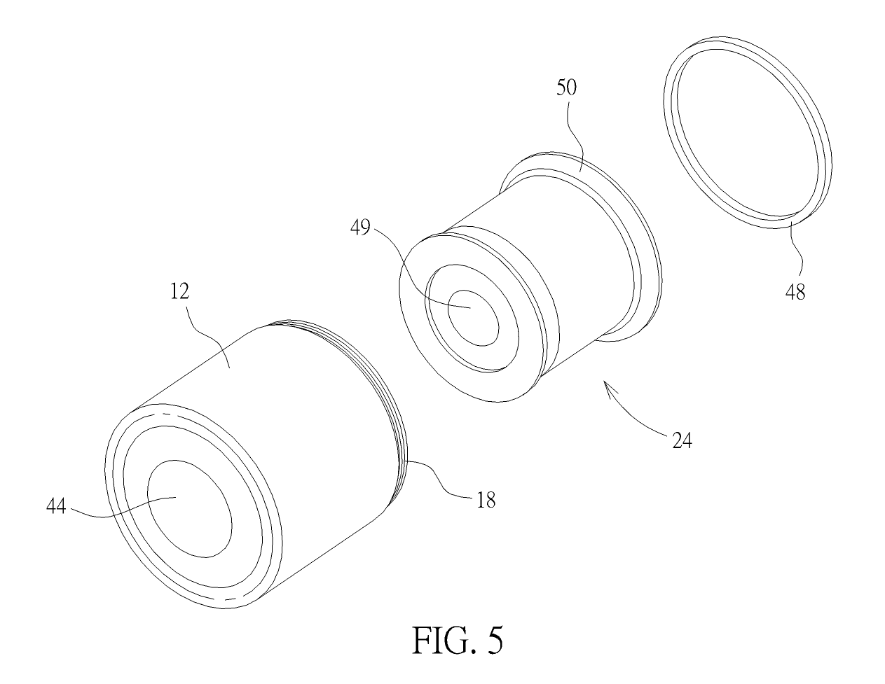

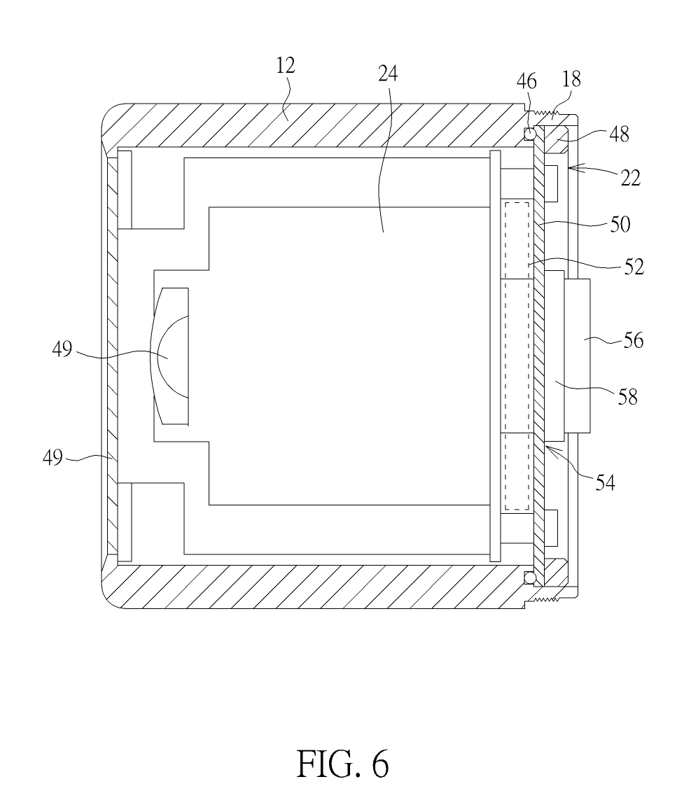

Please refer to FIG. 5 and FIG. 6. FIG. 5 is an exploded diagram of the first housing 12 and the lens module 24 according to an embodiment of the present invention. FIG. 6 is a sectional view of the first housing 12 and the lens module 24 according to the embodiment of the present invention. The camera device 10 further includes a transparent component 44, a moisture-proof component 46 and a fixing component 48. The transparent component 44 may be made of glass or plastic. The transparent component 44 is disposed on the other edge of the first housing 12 opposite to the first encircled portion 18 in a hermetically sealed manner. A camera lens 49 of the lens module 24, which is disposed inside the first housing 12, faces toward the transparent component 44. A base 50 of the lens module 24 is fixed on the edge of the first housing 12. The base 50 is adjacent to the first encircled portion 18, and the first opening 22 is sealed by the base 50 to prevent assembly of the first housing 12 and the lens module 24 from the moisture leakage.

The moisture-proof component 46 made of impermeable material can be disposed between the base 50 and the first housing 12. The fixing component 48 is utilized to press the base 50 on the first housing 12 by engaging with an inner surface of the first encircled portion 18, and to drive the moisture-proof component 46 to be resiliently deformed for the moisture resistance. The fixing component 48 can be made of metal material to enhance combination strength of the fixing component 48 and the first encircled portion 18. The fixing component 48 and the first encircled portion 18 can be annular structures, thread structures can be formed on adjacent surfaces of the fixing component 48 and the first encircled portion 18, and the fixing component 48 is rotatably engaged with the inner surface of the first encircled portion 18 via the thread structures.

In addition, the camera device 10 further includes a moisture-absorbing component 52 disposed on the base 50 of the lens module 24. The moisture-absorbing component 52 is utilized to absorb moisture inside the housing whereinside the lens module 24 is disposed. It should be mentioned that the moisture-absorbing component 52 may be exchangeable since the fixing component 48 is designed to be easily removed from the housing (such as the first housing 12) to clean out the lens module 24. The moisture-absorbing component 52 further can be unexchangeable since the fixing component 48 cannot be detached from the housing (such as the first housing 12). Application of the moisture-absorbing component is not limited to the above-mentioned embodiments, and depends on design's demand.

As shown in FIG. 2 to FIG. 4 and FIG. 6, at least one hole 54 is formed on the base 50 of the lens module 24. The lens module 24 further includes at least one connector 56 and at least one watertight component 58. Amounts of the hole 54 and the watertight component 58 correspond to an amount of the connector 56. Because the lens module 24 is disposed inside the first housing 12 in the hermetically sealed manner, the connector 56 passes through the hole 54 to protrude from the base 50 for connecting with a terminal 59 of the detachable component 32 since the first housing 12 is assembled with the second housing 14, and the detachable component 32 (such as the drive motor) can drive zoom in/out function of the lens module 24 via connection between the connector 56 and the terminal 59. The watertight component 58 made of impermeable material can be disposed between the hole 54 and the connector 56 to prevent the hole 54 from the moisture leakage. The connector 56 may preferably be a board-to-board connector.

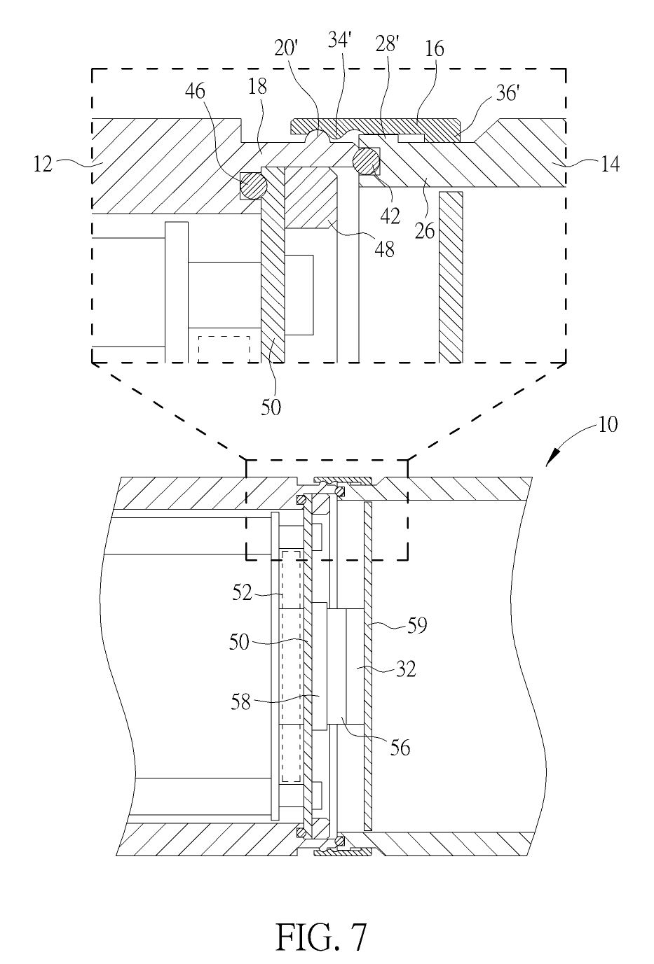

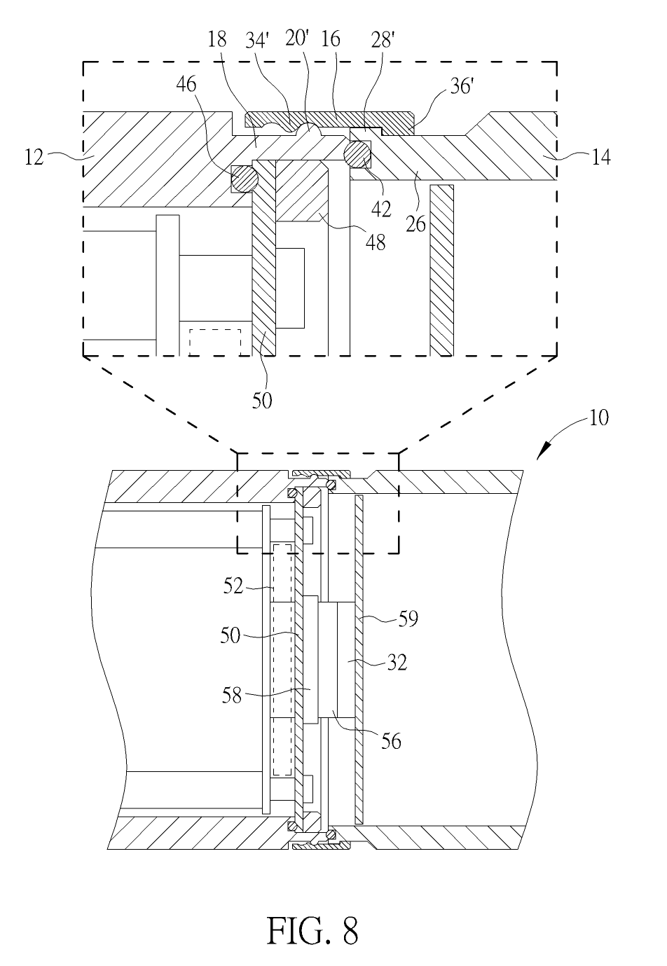

Please refer to FIG. 7 and FIG. 8. FIG. 7 and FIG. 8 respectively are sectional views of the camera device 10 in different operational modes according to a second embodiment of the present invention. The camera device 10 includes the first housing 12, the second housing 14 and the connecting component 16. Difference between the first embodiment and the second embodiment is that: the first engaging portion 20′ of the first housing 12 and the second gaging portion 34′ of the connecting component 16 are protrusions, the first contacting portion 28′ of the second housing 14 and the second contacting portion 36′ of the connecting component 16 are blocks (or the thread structure as the first embodiment). The second gaging portion 34′ is engaged with the first engaging portion 20′ by structural deformation.

The second gaging portion 34′ is located by a side of the first engaging portion 20′ and the second contacting portion 36′ slidably moves above the second encircled portion 26 since the connecting component 16 is located on position shown in FIG. 7, the second housing 14 is disassembled with the first housing 12. As the second contacting portion 36′ moves relative to the second encircled portion 26, the second gaging portion 34′ moves across the first engaging portion 20′ by the structural deformation to tightly contact the second contacting portion 36′ against the first contacting portion 28′, as shown in FIG. 8, the first housing 12 and the second housing 14 can be stably assembled by the connecting component 16.

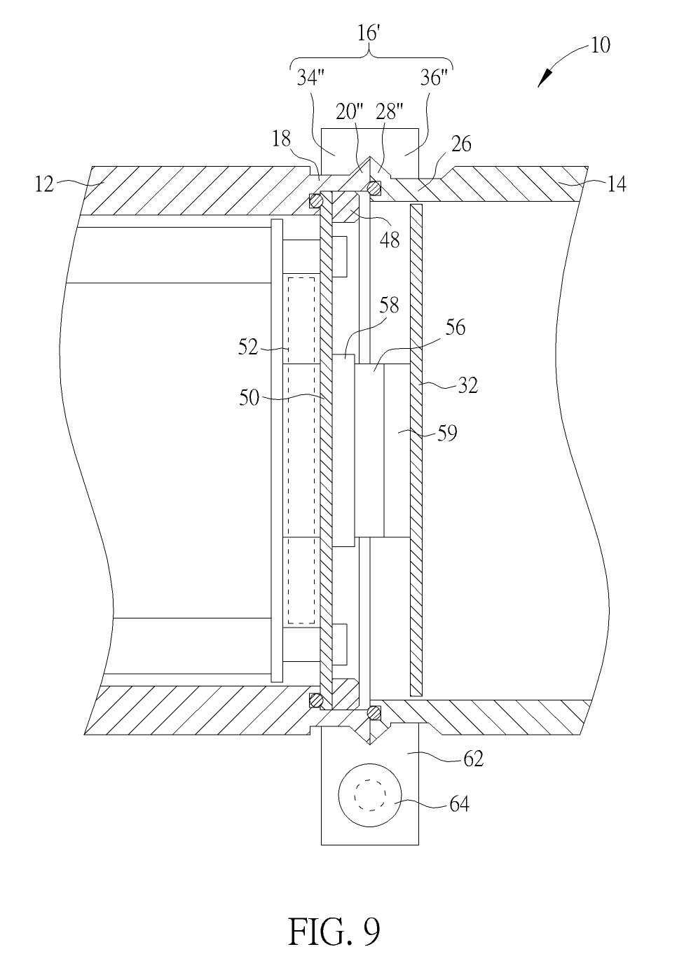

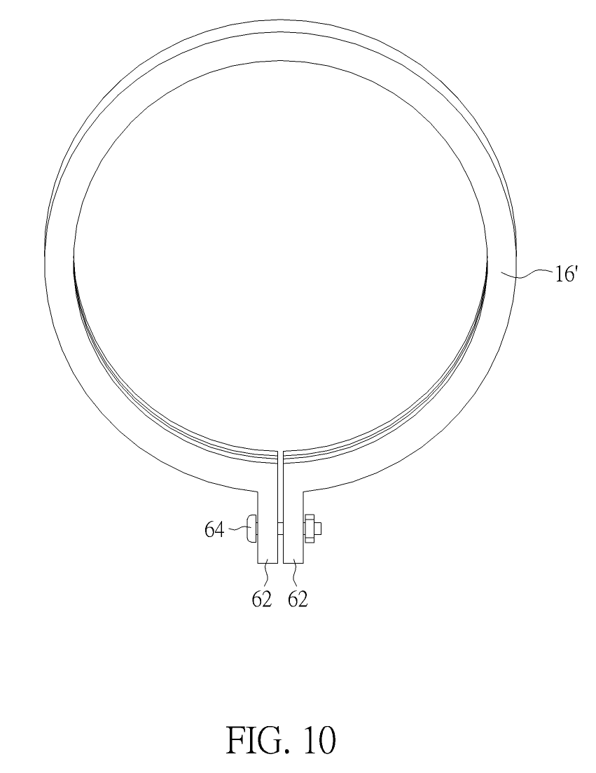

Please refer to FIG. 9 and FIG. 10. FIG. 9 is a sectional view of the camera device 10 according to a third embodiment of the present invention. FIG. 10 is a diagram of the connecting component 16′ according to the third embodiment of the present invention. In the third embodiment, the first engaging portion 20″, the first contacting portion 28″, the second engaging portion 34″ and the second contacting portion 36″ are inclined structures. The connecting component 16′ further includes two locking hole portions 62 and a locking portion 64. The locking hole portions 62 are respectively disposed on ends of the connecting component 16′. The locking portion 64 passes through the two locking hole portions 62 to press the second engaging portion 34″ on the first engaging portion 20″, and to press the second contacting portion 36″ on the first contacting portion 28″. Thus, the second engaging portion 34″ slides relative to the first engaging portion 20″, the second contacting portion 36″ slides relative to the first contacting portion 28″, and the first encircled portion 18 and second encircled portion 26 can be moved close to each other for the moisture resistance.

In the above-mentioned embodiments, elements of each embodiment having the same numeral as ones of another embodiment have the same structures and functions, and a detailed description is omitted herein for simplicity.

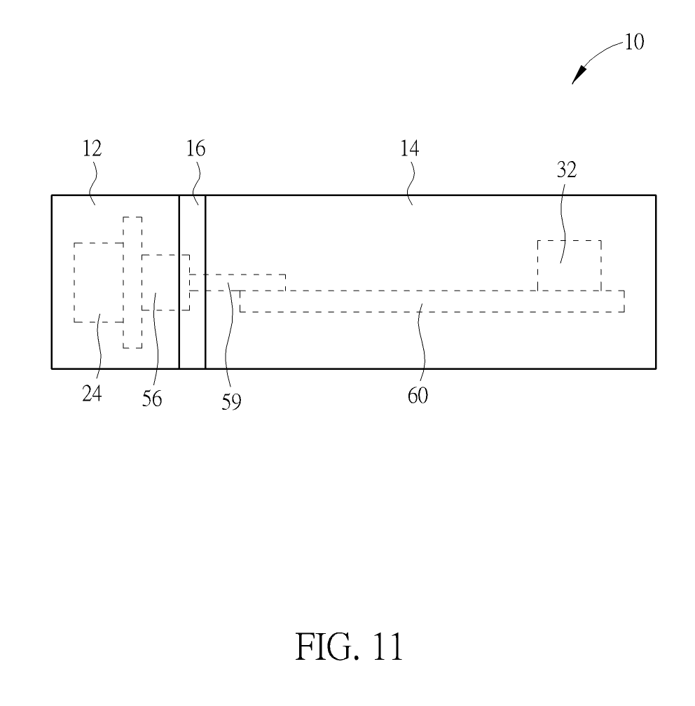

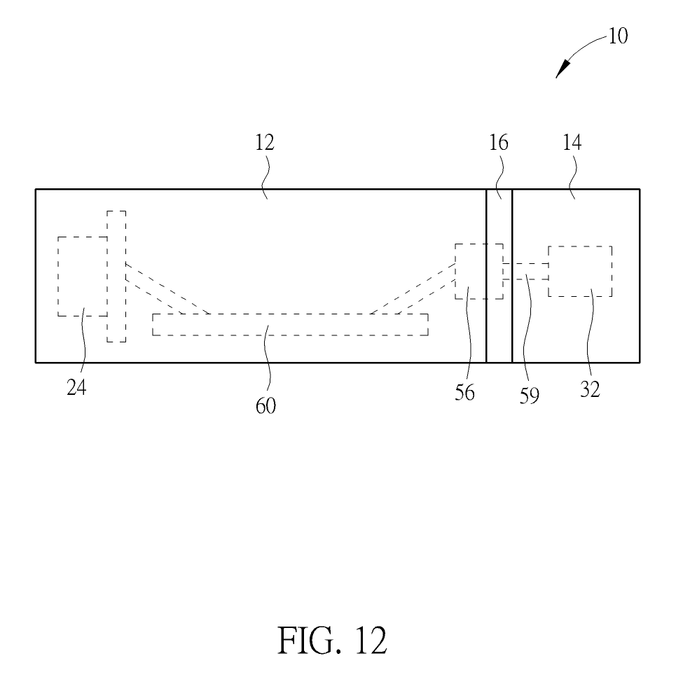

Please refer to FIG. 11 and FIG. 12. FIG. 11 and FIG. 12 respectively are diagrams of the camera device 10 according to different embodiments of the present invention. The camera device 10 includes two independent containers (the first housing 12 and the second housing 14) whereinside the lens modules 24 and the detachable component 32 are respectively disposed. Dimension of the first housing 12 and the second housing 14 may be designed according to position of a main board 60 of the camera device 10. The main board 60 may be disposed inside the second housing 14, which accordingly owns a greater size, as shown in FIG. 11. The main board 60 may further be disposed inside the first housing 12, which accordingly owns the greater size, as shown in FIG. 12. Disposition of the main board 60 is not limited to the above-mentioned embodiments, and depends on actual's demand. Design of the camera device 10 with the sealed housing (whereinside the lens module 24 is disposed) gained independence from the other housing (whereinside the detachable component 32 is disposed) belongs to scope of present invention.

Comparing to the prior art, the camera device utilizes two independent housings to respectively accommodate the lens module and the detachable component, and further utilizes the connecting component to eliminate any gap between the housings. The first housing is hermetically sealed to prevent the lens module from damage by moisture. The board-to-board connector of the lens module protrudes from the sealed first housing to connect with the terminal of the detachable component. The second housing can be disassembled from the first housing to exchange/repair the detachable component; meanwhile, the first housing keeps sealed package to protect the lens module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A camera device comprising:
a first housing comprising:
a first encircled portion disposed on an edge of the first housing, a first opening being formed on an encircled area of the first encircled portion; and
a first engaging portion disposed on an outer surface of the first encircled portion;
a second housing comprising:
a second encircled portion disposed on an edge of the second housing, a second opening being formed on an encircled area of the second encircled portion, and the second encircled portion contacting against the first encircled portion to connect the first opening and the second opening; and
a first contacting portion disposed on an outer surface of the second encircled portion; and
a connecting component movably disposed on the first encircled portion and the second encircled portion to assemble the first housing with the second housing, the connecting component comprising:
a second engaging portion disposed on a side of the connecting component to engage with the first engaging portion; and
a second contacting portion disposed on the other side of the connecting component to contact against the first contacting portion since the first engaging portion and the second engaging portion are engaged.

2. The camera device of claim 1, wherein the camera device further comprises a lens module and a detachable component respectively disposed inside the first housing and the second housing.

3. The camera device of claim 1, further comprising:
a waterproof component disposed between the first encircled portion and the second encircled portion, the waterproof component being adapted to simultaneously contact against the first encircled portion and the second encircled portion in a resiliently deformable manner.

4. The camera device of claim 1, wherein the first encircled portion, the second encircled portion and the connecting component are annular structures, the second engaging portion is rotatably engaged with the first engaging portion so as to press the second contacting portion on the first contacting portion.

5. The camera device of claim 4, wherein the first engaging portion and the second engaging portion are thread structures or protrusions.

6. The camera device of claim 1, wherein the outer surface of the second encircled portion comprises a first area and a second area, the first contacting portion is disposed on the first area, the second contacting portion slidably moves within the second area since the connecting component is assembled with the second housing.

7. The camera device of claim 6, wherein the first contacting portion and the second contacting portion are thread structures.

8. The camera device of claim 1, wherein the first engaging portion, the first contacting portion, the second engaging portion and the second contacting portion are inclined structures.

9. The camera device of claim 8, wherein the connecting component further comprises:
two locking hole portions respectively disposed on ends of the connecting component; and
a locking portion passing through the two locking hole portions to press the second engaging portion on the first engaging portion, and to press the second contacting portion on the first contacting portion.

10. The camera device of claim 1, wherein the first housing further comprises a main body whereon the first encircled portion is disposed, a diameter of the first encircled portion is smaller than a diameter of the main body, and a thickness of the connecting component is substantially equal to diameter difference between the first encircled portion and the main body.

11. The camera device of claim 1, further comprising:
a transparent component disposed on the other edge of the first housing opposite to the first encircled portion in a hermetically sealed manner.

12. The camera device of claim 2, wherein a base of the lens module is fixed on the edge of the first housing to seal the first opening.

13. The camera device of claim 12, further comprising:
a moisture-proof component disposed between the base and the first housing.

14. The camera device of claim 12, further comprising:
a fixing component engaged with an inner surface of the first encircled portion to press the base on the first housing.

15. The camera device of claim 14, wherein the fixing component is an annular structure, the fixing component is rotatably engaged with the inner surface of the first encircled portion via thread structures.

16. The camera device of claim 12, further comprising:
a moisture-absorbing component disposed on the base of the lens module.

17. The camera device of claim 12, wherein a hole is formed on the base of the lens module, the lens module comprises a connector and a watertight component, the connector passes through the hole to connect with a terminal of the detachable component, and the watertight component is disposed between the hole and the connector.

18. The camera device of claim 17, wherein the connector of the lens module is a board-to-board connector.
